(19) United States
(12) Patent Application Publication
(10) Pub. No.: US 2010/0317483 A1
(43) Pub. Date: Dec. 16, 2010

(54) HIGH PERFORMANCE DIFFERENTIAL

(75) Inventor: Stephen P. Radzevich, Sterling Heights, MI (US)

Correspondence Address: DYKEMA GOSSETT PLLC, 39577 WOODWARD AVENUE, SUITE 300, BLOOMFIELD HILLS, MI, 48304-5086, US

(73) Assignee: Eaton Corporation, Cleveland, OH (US)

(21) Appl. No.: 12/481,918

(22) Filed: Jun. 10, 2009

(51) Int. Cl. F16H 55/08; F16H 48/06

(52) U.S. Cl. 475/230; 74/462

(57) ABSTRACT

A gear set includes a first gear having at least one tooth with a first tooth profile. The first tooth profile may comprise a first segment comprising a first plurality of sections. At least one of the first plurality of sections may have a first profile angle, and at least one of the first plurality of sections may have a second profile angle. The first profile angle and the second profile angle may be different. A differential is also provided that includes a differential case, a pinion shaft disposed inside the differential case, and a pinion gear.

### TECHNICAL FIELD

The present invention relates to a gear set, including a gear set with a first gear having at least one tooth with a tooth profile that is configured to allow for increased contact load at certain locations along the tooth profile, thereby allowing increased torque density through a differential incorporating the gear set.

### BACKGROUND

A gear tooth with a conventional tooth profile may have an unfavorable distribution of stress along the tooth profile. In particular, a gear tooth with a conventional tooth profile may be weaker at certain locations along the tooth profile. For example, referring to FIG. 1A, the weakest areas of the gear tooth may be the locations labeled (A) and (B) (i.e., where the top of the profile meets the profile of the tooth flank and where the bottom of the profile meets the profile of the tooth flank). Furthermore, the contact stresses acting on the gear tooth when it is in meshed engagement with another gear tooth is not constant along the tooth profile. This means that not every point of contact is loaded equally. The amount of contact stress at a location along the tooth profile depends on the tooth profile angle. Referring now to FIG. 1B, the contract stresses are actually highest at the locations labeled (A) and (B), and the contact stresses are lowest at the pitch point P^{(op)} of the tooth profile. For tooth profiles of gears operating on parallel axes (e.g., cylindrical gears), the common normal at all points of contact pass through a fixed point on the line of centers, called a pitch point. As a first and second gear rotate, the gear tooth profiles contact each other at different positions. The locus of successive contact points for a given pair of gear tooth profiles is called the “path of line of action” and/or “path of contact.” The pitch point for cylindrical gears may be the intersection of the line of centers and the line of action.

It may be desirable to equalize contact stress along the entire tooth profile or to improve the distribution of stress along the tooth profile.

### SUMMARY

A gear set includes a first gear having at least one tooth with a first tooth profile. The first tooth profile may comprise a first segment comprising a first plurality of sections. At least one of the first plurality of sections may have a first profile angle, and at least one of the first plurality of sections may have a second profile angle. The first profile angle and the second profile angle may be different.

A differential includes a differential case, a pinion shaft disposed inside the differential case, and a pinion gear. The pinion gear may have at least one tooth with a first tooth profile. The first tooth profile may comprise a first segment comprising a first plurality of sections. At least one of the first plurality of sections may have a first profile angle, and at least one of the first plurality of sections may have a second profile angle. The first profile angle and the second profile angle may be different.

The inventive gear set may increase torque density through a differential incorporating the inventive gear set, thereby improving performance of the differential.

### BRIEF DESCRIPTION OF THE DRAWINGS

Embodiments of the invention will now be described, by way of example, with reference to the accompanying drawings, wherein:

FIG. 1A is a schematic view of a tooth profile.

FIG. 1B is a graph depicting contact stress on a tooth profile at various locations.

FIG. 2 is a schematic section view of a differential incorporating a gear set in accordance with an embodiment of the invention.

FIG. 3 is a perspective view of a differential incorporating a gear set in accordance with an embodiment of the invention.

FIG. 4A is a perspective view of a pinion gear having a tooth flank.

FIG. 4B is a perspective view of a side gear having a tooth flank.

FIG. 5 is a schematic of the contact between the tooth flank surfaces of a first gear and second gear in accordance with an embodiment of the invention.

FIG. 6 is a schematic of the line of action between a first gear and a second gear in accordance with an embodiment of the invention.

FIG. 7 is a schematic of a gear base cone for a first or second gear of FIG. 4.

FIG. 8 is a schematic depiction of tooth pointing and tooth undercutting of a tooth flank on a side gear of a gear set.

FIG. 9 is a schematic view of a modified auxiliary rack for generating a modified tooth profile for a first gear or second gear in accordance with an embodiment of the invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as embodied by the appended claims.

FIG. 2 illustrates a schematic section view of a gear set 10 in accordance with an embodiment of the present invention. The gear set 10 may be utilized in a differential 12. The differential 12 may include a differential case 14 and a pinion shaft 16. The pinion shaft 16 may comprise either a cross or straight shaft and may be fixed inside the differential case 14. The differential 12 may further include a first gear 18 (e.g., at least one pinion gear). The differential may further include a second gear 20 (e.g., at least one side gear). The first gear 18 may comprise a straight bevel pinion gear, and the second gear may comprise a straight bevel side gear. Although the gear set 10 is described as comprising pinion gear 18 and second gear 20 configured for use in a differential 12, the first and second gears that may make up gear set 10 may comprise any number of different gears in other embodiments of the invention.

The pinion gear 18 may be supported by the pinion shaft 16. There may be a plurality of pinion gears 18 in an embodiment of the invention. For example, there may be two or four pinion gears 18 in an embodiment of the invention. Although these particular numbers of pinion gears have been mentioned in detail, there may be fewer or more pinions 18 in other embodiments of the invention. The pinion gears 18 may be configured for engagement with side gear 20. There may be a plurality of side gears in an embodiment of the invention. For example, there may be two side gears 20 in an embodiment of the invention. Although this particular number of side gears has been mentioned in detail, there may be fewer or more side gears 20 in other embodiments of the invention.

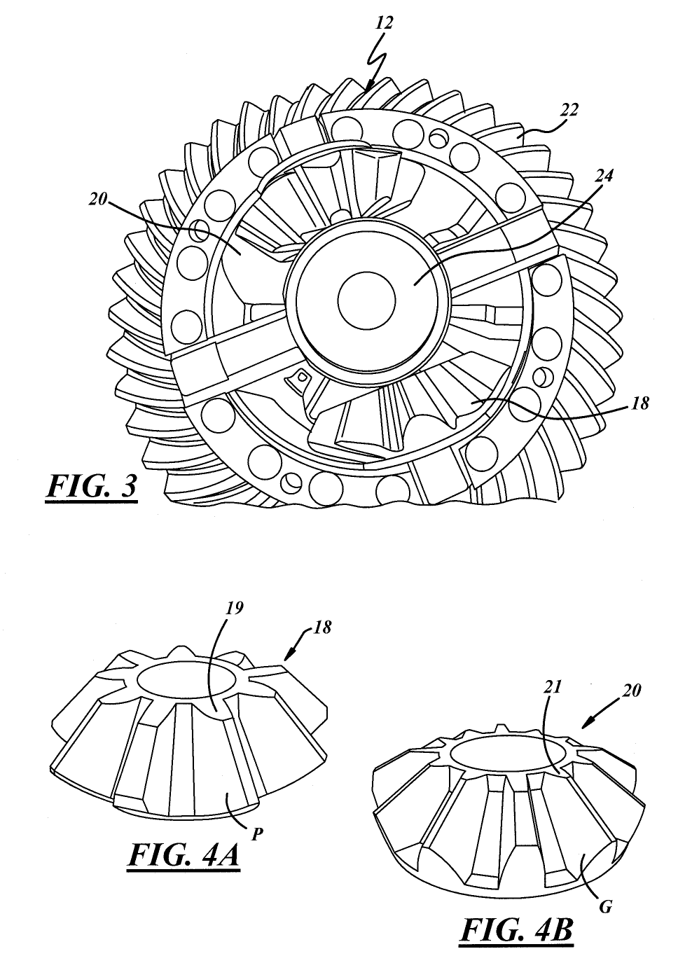

Referring now to FIG. 3, the differential 12 may further include a ring gear 22 and spider 24. Rotation from the ring gear 22 may be transferred to differential case 14, to the spider 24, and then ultimately through the pinion gears 18 to the side gears 20. Referring back to FIG. 2, the differential 12 may further include a at least one spherical thrust washer 26 disposed between the back sides of the pinion gears 18 and the differential case 14. The differential 12 may further include at least one flat thrust washer 28 disposed between the back sides of the side gears 20 and the differential case 14. The differential 12 may be adapted to allow different rotational speeds between two side gears 20 disposed within differential case 14.

Referring now to FIG. 4A, the first gear (e.g., pinion gear 18) may include at least one tooth 19 having a first tooth flank P. The tooth 19 of the pinion gear 18 may be bounded by two lateral surfaces that are commonly referred to as tooth flanks (i.e., tooth flank P). The tooth 19 of the pinion gear 18 may also have a first tooth profile. The first tooth profile may be a line of intersection of the tooth flank P by a transverse plane (i.e., a cross-section of the tooth 19). Referring now to FIG. 4B, the second gear (e.g., side gear 20) may include at least one tooth 21 having a second tooth flank G. The tooth 21 of the side gear 20 may be bounded by two lateral surfaces that are commonly referred to as tooth flanks (i.e., tooth flank G). The tooth 21 of the side gear 20 may also have a second tooth profile. The second tooth profile may be a line of intersection of the tooth flank G by a transverse plane (i.e., a cross-section of the tooth 21). Torque density through the differential of conventional design is often limited by the maximal contact stresses between interacting flanks P, G of the teeth 19, 21 of the pinion 18 and side gear 20, respectively, (e.g., between the first tooth flank P of tooth 19 of pinion gear 18 and the second tooth flank G of tooth 21 of side gear 20). The value of contact stress at a particular location along the tooth profile of a gear tooth 19, 21 depends on the tooth profile angle θ_{g}. For example, when two convex surfaces meet (e.g., the engagement of two gear tooth profiles), a contact stress may be generated.

By increasing the maximal allowed contract stress between the first tooth flank P of pinion gear 18 and the second tooth flank G of side gear 20, then the allowed limit contact load is increased and torque density through the differential 12 may be increased. Modification to the first tooth flank P of pinion gear 18 and the second tooth flank G of side gear 20 may be made in accordance with an embodiment of the invention to try to simulate the meeting of a convex and concave surface (rather than the meeting of two convex surfaces) when the first and second tooth flanks P, G are in meshed engagement. In particular, the potential contact stress may be decreased as the radii of curvature of each of the gears is increased. In contrast, the potential contact stress may be increased as the radii of curvature of each of the gears is decreased. Accordingly, a higher contact load may be permissible if the normal curvature of the first tooth flank of the pinion gear 18 and the second tooth flank of the side gear 20 is decreased, and the radii of curvature is increased.

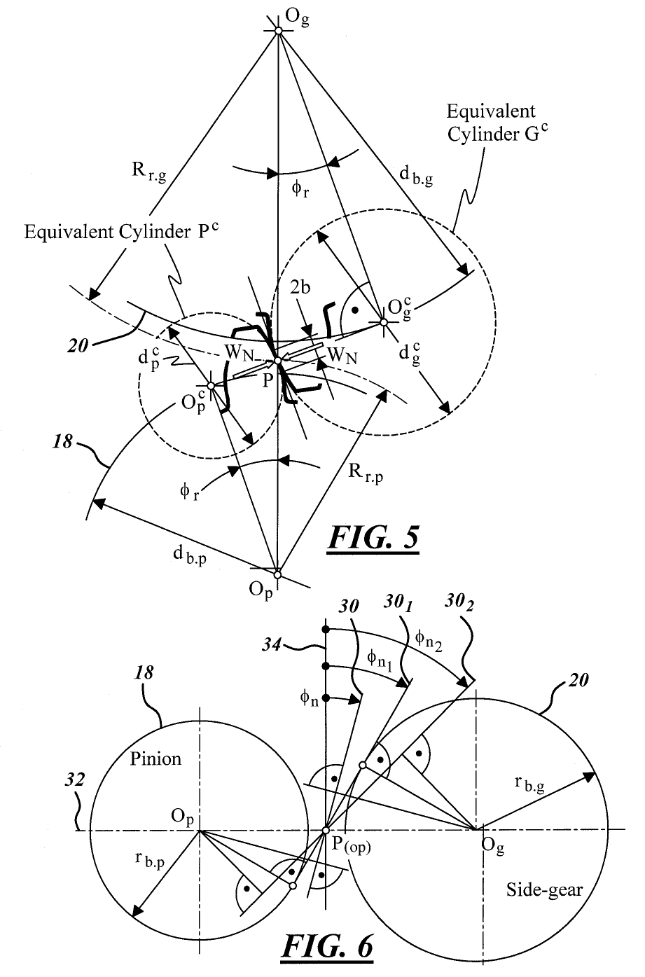

Referring to FIG. 5, the radii of curvature for tooth flank P of pinion gear 18 is represented as R_{r.p}, and the radii of curvature for tooth flank G of side gear 20 is represented as R_{r.g}. At the point of contact, tooth flanks P, G may be substituted with equivalent cylinders P^{c}, G^{c}. The substitution for the tooth flanks P, G allows for a reasonable approximation of curved tooth flanks P, G having complex geometry with the use of equivalent cylinders P^{c}, G^{c} which have relatively simple geometry. The radii of curvature R_{r.p}, R_{r.g} for the tooth flanks P, G of pinion gear 18 and side gear 20, respectively, may be substantially equal to the radii of the equivalent cylinders P^{c}, G^{c}. The radii of the equivalent cylinders G^{c}, P^{c} are equal to one half of dₚ^{c}, d_{g}^{c}, respectively.

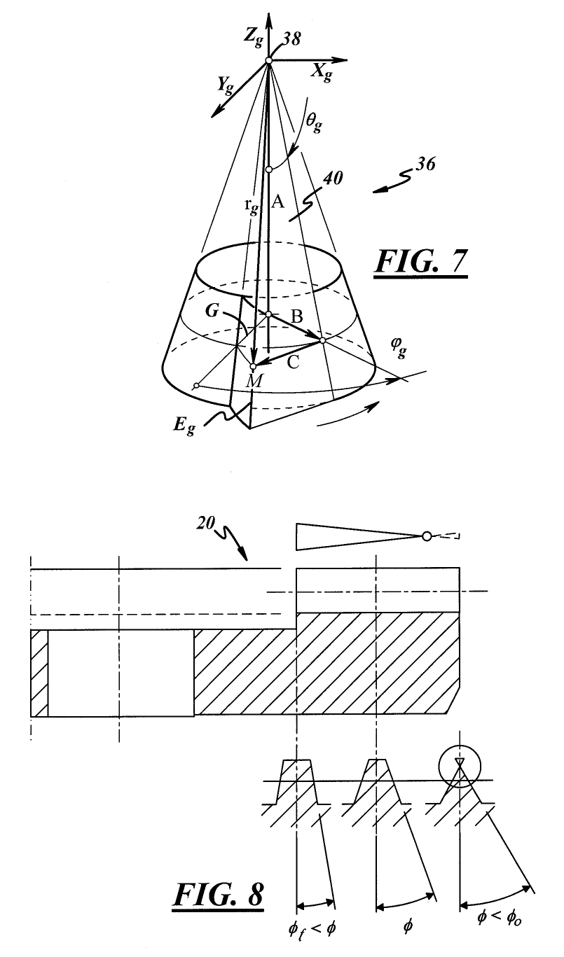

In order to increase contact load of the pinion gear 18 and side gear 20), it may be desirable to decrease the normal curvature of the first tooth flank P of the pinion gear 18 and the second tooth flank G of the side gear 20 or, in other words, to increase the radii of curvature R_{r.p}, R_{r.g}. To decrease the normal curvature of the tooth flanks P, G (or in other words to increase the radii of curvature R_{r.p}, R_{r.g}), the pressure angle and/or profile angle φₙ in the pinion gear 18 to side gear 20 mesh may be increased or the base cone angle θ_{g} of the pinion gear 18 or side gear 20 may be decreased. In order to illustrate the pressure angle and/or profile angle φₙ in the pinion gear 18 to side gear 20 mesh or the base cone angle θ_{g} of the pinion gear 18 or side gear 20, reference is now made to FIGS. 6-7.

A plane of action may comprise the contact points between the first tooth flank P of the pinion gear 18 and the second tooth flank G of the side gear 20. For improving understanding of the plane of action, FIG. 6 illustrates a schematic of a line of action 30, 30₁, 30₂ between a pinion gear 18 and side gear 20. A line of action 30, 30₁, 30₂ may be used for two-dimensional geometry, and a plane of action may be used for three-dimensional geometry. Gears 18, 20 may make contact along the line of action 30, 30₁, 30₂. The pinion gear 18 may have a center point Oₚ, and the side gear 20 may have a center point O_{g}. A central line 32 may run between the center points Oₚ and O_{g}. The pitch point P^{(op)} may be the intersection of the central line 32 and the line of action 30, 30₁, 30₂. A line 34 may run perpendicular (i.e., normal) to the central line 32 through the pitch point P^{(op)}. The pressure angle and/or profile angle φₙ, φₙ₁, φₙ₂ is the angle between the perpendicular (i.e., normal) line 34 and the line of action 30, 30₁, 30₂. The radii of the base cylinders P^{c}, G^{c} of the pinion 18 and side gear 20, r_{b.p}, r_{b.g}, extend from the center points θₚ and θ_{g} to the line of action 30, 30₁, 30₂. Each contact point between the first tooth flank P of the pinion gear 18 and the second tooth flank G of the side gear 20 may be indicated in terms of polar coordinates. Each contact point may be located at a certain distance from the pitch point P^{(op)} and at a certain pressure angle φₙ from the line 34 that is normal to the line 32 connecting the center points Oₚ. O_{g} of the pinion gear 18 and side gear 20. Referring now to FIG. 7, a gear base cone 36 for a pinion gear 18 and/or a side gear 20 is illustrated. The gear tooth flank P, G may have a surface represented as the loci of a straight line E_{g} through the apex 38 and within the tangent plane 40 with a base cone angle θ_{g}. Plane 40 is tangent to base cone 36 and rolls over the base cone 36 without sliding. Once the plane 40 is rolling over the gear base cone 36, then it is tangent to the gear base cone 36. The locus of successive positions of a line within the plane 40 form a corresponding tooth flank G. A position vector r_{g} specifies the X_{g}, Y_{g}, Z_{g} coordinates of points of the tooth flank G of the side gear 20. Although the gear base cone 36 is illustrated in connection with gear tooth flank G (i.e., tooth flank G for a side gear 20), a gear base cone 36 may also be used in connection with gear tooth flank P for a corresponding pinion gear 18. The angle of rotation for the side gear 20 is represented as φ_{g}. Again, although the angle of rotation is represented for a side gear 20, the angle of rotation for the pinion gear 18 may be represented by φ_{g} of FIG. 7 as well.

Simply increasing the pressure angle φₙ in the pinion gear 18 to side gear 20 mesh or decreasing the base cone angle θ_{g} of the side gear 20 may result in tooth pointing. Referring now to FIG. 8, tooth pointing may particularly occur at the outer diameter of the side gear 20 and tooth undercutting may occur at the inner diameter of the side gear 20. Although FIG. 8 illustrates tooth pointing and/or tooth undercutting in connection with a side gear 20, tooth pointing and tooth undercutting may also occur in connection with a pinion gear 18. Tooth pointing may result in the pointing of the top profile of the tooth, such that the angle φₒ of the flank of the pointed tooth is greater than angle φ of the flank of the normal tooth (i.e., a tooth not exhibiting pointing or undercutting). Tooth undercutting may result in the increased flattening of the top profile of the tooth, such that the angle φ_{f} of the flank of the undercut tooth is less than the angle φ of the flank of the normal tooth. Both tooth pointing and tooth undercutting are undesirable. In particular, tooth pointing may reduce the torque capacity of a gear set and should be eliminated.

In order to achieve increased contact load through the increased pressure angle φₙ in the pinion gear 18 to side gear 20 mesh or the decreased base cone angle θ_{g} of the side gear 20 without causing undesired tooth pointing, modification to the first tooth flank P and corresponding first tooth profile of pinion gear 18 and the second tooth flank G and corresponding second tooth profile of side gear 20 may be utilized in accordance with an embodiment of the invention.

In order to determine and/or compute contact stress in the pinion gear 18 to side gear 20 mesh, the following equation may be utilized.

$${σ}_{c} = \frac{2 \cdot W}{π \cdot b \cdot L} \qquad ( Equation 1 )$$

In connection with Equation 1, σ_{c}=contact stress in the pinion gear 18 to side gear 20 mesh, W=contact load normal to the tooth flank surfaces, b=semi-width of contact between the tooth flank surfaces P, G, and L=the minimal total length of contact between the tooth flank surfaces P, G. Referring again to FIG. 5, a schematic of the contact between the tooth flanks P, G of the pinion gear 18 and side gear 20 is illustrated. In order to determine and/or compute the semi-width of contact between the tooth flank surfaces b, the following equation may be utilized.

$$b = \sqrt{\frac{W}{π \cdot L} \cdot \frac{\frac{1 - {μ}_{p}^{2}}{{E}_{p}} + \frac{1 - {μ}_{g}^{2}}{{E}_{g}}}{\frac{1}{{ρ}_{p}} + \frac{1}{{ρ}_{g}}}} \qquad ( Equation 2 )$$

In connection with Equation 2, μₚ, μ_{g}=Poisson's ratio of material of the pinion gear 18 and of the side gear 20, Eₚ, E_{g}=modulus of elasticity of material of the pinion gear 18 and of the side gear 20, and ρₚ, ρ_{g}=radii of normal curvature of the first tooth flank P of the pinion gear 18 and the second tooth flank G of the side gear 20. The radii ρₚ, ρ_{g} are measured in the cross-section that is orthogonal to the line of contact 30, 30₁, 30₂ of the first tooth flank of the pinion gear 18 and the second tooth flank of the side gear 20. The radii ρₚ, ρ_{g} of the tooth flanks P, G set forth in Equation 2 may also be represented herein as R_{r.p}, R_{r.g} as illustrated in FIG. 5.

Equations 1 and 2 confirm that the contact load can be increased by increasing the radii of normal curvature ρₚ, ρ_{g}. Referring again to FIGS. 4A-4B, a pinion gear 18 with tooth 19 with tooth flank P and a side gear 20 with tooth 21 with tooth flank G are illustrated. Referring back to FIG. 7, the position vector r_{g} specifies the X_{g}, Y_{g}, Z_{g} coordinates of points of the tooth flank P, G of either the pinion gear 18 and/or the side gear 20. The position vector r_{g} of a point M of the tooth flank P, G can be represented as a summa of three vectors. Although the illustrated tooth flank is flank G of side gear 20, the same position vector may be utilized for tooth flank P of pinion gear 18. The equation for the position vector r_{g} is as follows:

r_{g}=A+B+C (Equation 3)

The vectors A, B, and C may be equal to the following:

A=−k·U_{g} (Equation 4)

B=i·U_{g} tan θ_{g} sin φ_{g}+j·Ug tan θ_{g} cos φ_{g} (Equation 5)

C=−i·φ_{g}U_{g} tan θ_{g} cos φ_{g}+j·φ_{g} U_{g} tan θ_{g} sinφ_{g} (Equation 6).

Referring to Equations 3-6, i, j, and k denote unit vectors along axes X_{g}, Y_{g}, Z_{g} (i.e., the element “i” is a vector of length 1 that is pointed along the axis “Xg”; the element “j” is a vector of length 1 that is pointed along the axis “Yg”, and the element “k” is a vector of length 1 that is pointed along the axis “Zg”) and U_{g} indicates the distance measured from the apex 38 to the projection of M onto the Z_{g} axis. The parameter U_{g} and φ_{g} are Gaussian curvilinear parameters of the gear tooth flank G. Again, similar equations and parameters may be used in connection with gear tooth flank P of pinion gear 18.

By substituting the vectors A, B, and C into the equation r_{g}=A+B+C, the equation for the tooth flank G for a side gear 20 (Equation 7) may be derived in matrix representation:

$${r}_{g} = [ \begin{matrix}{U}_{g} tan {θ}_{g} sin {ϕ}_{g} - {ϕ}_{g} \cdot {U}_{g} \cdot tan {θ}_{g} cos {ϕ}_{g} \\ {U}_{g} tan {θ}_{g} cos {ϕ}_{g} + {ϕ}_{g} \cdot {U}_{g} \cdot tan {θ}_{g} sin {ϕ}_{g} \\ - {U}_{g} \\ 1\end{matrix} ] \qquad ( Equation 7 )$$

The equation for the tooth flank P for a pinion gear 18 (Equation 8) may be derived in matrix representation:

$${r}_{p} = [ \begin{matrix}{U}_{p} tan {θ}_{p} sin {ϕ}_{p} - {ϕ}_{p} \cdot {U}_{p} \cdot tan {θ}_{p} cos {ϕ}_{p} \\ {U}_{p} tan {θ}_{p} cos {ϕ}_{p} + {ϕ}_{p} \cdot {U}_{p} \cdot tan {θ}_{p} sin {ϕ}_{p} \\ - {U}_{p} \\ 1\end{matrix} ] \qquad ( Equation 8 )$$

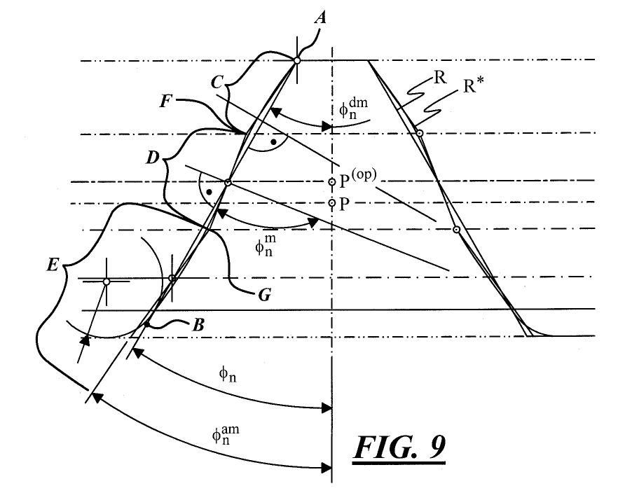

Referring now to FIG. 9, a schematic of a modified tooth profile for a tooth on pinion gear 18 and/or side gear 20 is illustrated. Equations 7 and 8 may yield computation of the first radius of curvature R_{1.g} for the tooth flank G of the side gear 20 and the first radius of curvature R_{1.p} for the tooth flank P of the pinion gear 18, as well as the second radius of curvature R_{2.g} for the tooth flank G of the side gear 20 and the second radius of curvature R_{2.p}. for the tooth flank P of the pinion gear 18. Each tooth flank P, G may have a first and second radius of curvature because of the modification to the tooth flank P, G as generally represented in FIG. 9. The first radii of curvature R_{1.g}, R_{1.p} may approach infinity. The second radii of curvature R_{2.g}, R_{2.p} may have values that depend upon design parameters for the pinion gear 18 and the side gear 20. The second radii of curvature R_{2.g}, R_{2.p} may be computed using Equations 7-8 following conventional equations for the computation of principal radii of curvature of a smooth regular surface that are known to those of ordinary skill in the art. The following equalities may be observed: ρₚ=R_{2.p} and ρ_{g}=R_{2.g}, since ρₚ, ρ_{g} comprise the radii of normal curvature of the first tooth flank P and tooth profile of the pinion gear 18 and the second tooth flank G and tooth profile of the side gear 20, respectively, in Equations 1-2. The radii of curvature ρₚ, ρ_{g} may be determined by one of ordinary skill in the art based on known design parameters for the pinion gear 18 and side gear 20. For example, the following equations may be used to determine the radii of normal curvature ρₚ, ρ_{g} for the first tooth flank P and tooth profile of the pinion gear 18 and the second tooth flank G and tooth profile of the side gear 20.

$$\begin{matrix}{ρ}_{g} = \frac{{d}_{g}}{2 \cdot sin {φ}_{n}} & ( Equation 9 ) \\ {ρ}_{g} = \frac{\sqrt{{d}_{g}^{2} - {d}_{b \cdot g}^{2}}}{2} & ( Equation 10 )\end{matrix}$$

Equation 9 indicates for a gear having a pitch diameter d_{g}, a larger normal pressure angle φₙ results in a larger radius of curvature ρ_{g} for the tooth flank P, G and tooth profile of the gear. Similarly, a smaller base diameter d_{b.g} also results in an increase in the radius of curvature ρ_{g} for the tooth flank P, G and tooth profile of the pinion gear 18 or side gear 20. The pitch diameter d_{g} is the diameter of the pitch circles of the equivalent cylinders P^{c}, G^{c} , and is generally illustrated in FIG. 5. The pitch surfaces make contact along the line (as generally illustrated), which is often referred to as a pitch line. The base diameter d_{b.g}. is the diameter of the base cone 36 from which involute tooth flank P, G is constructed, and the base cone 36 is generally illustrated in FIG. 7.

Referring to FIG. 9, the conventional auxiliary rack and/or basic rack R may comprise an imaginary and/or phantom rack that is in proper mesh with both the tooth flanks of a conventional pinion gear and side gear. The auxiliary rack R does not physically exist, but may be useful to simplify derivation of the equations that may be used for the computation of the geometry of the gear tooth flanks of a conventional pinion gear and a conventional side gear. While the auxiliary rack may itself have a certain tooth profile, the auxiliary rack may be used for the purpose of generation of the pinion gear tooth profile and the side gear tooth profile and may significantly simplify the description of the tooth profiles. Accordingly, the auxiliary rack R may be used to generate the first tooth profile of pinion gear and the second tooth profile of side gear of a conventional profile. FIG. 9 also illustrates a modified auxiliary rack R*. The modified auxiliary rack R* may be used to generate the first tooth profile of pinion gear 18 and the second tooth profile of side gear 20 that has been modified in accordance with an embodiment of the invention. Accordingly, the first tooth profile of the pinion gear 18 having at least one tooth with a tooth flank P and the second tooth profile of the side gear 20 having at least one tooth with a tooth flank G may be generated by the modified auxiliary rack R*.

Increases in the tooth profile angle compared to the tooth profile angle of a conventional tooth flank for a conventional pinion gear and/or side gear at one or more particular locations along the tooth flank of the gear teeth on the pinion gear and/or side gear may decrease the amount of contact stress on the gear tooth at those particular locations. Accordingly, modified tooth flank P, G of pinion gear 18 and side gear 20 in accordance with an embodiment of the invention may result in a modified first tooth profile for pinion gear 18 and a modified second tooth profile for side gear 20. Each modified tooth profile comprises a segment having a plurality of sections (e.g., three sections), in which one or more of the plurality of sections has an increased pressure angle. Pinion gear 18 may thus have a first tooth profile. The first tooth profile may comprise a first segment comprising a plurality of sections. The first segment of the first tooth profile may correspond to the flank P of the tooth 19 on a pinion gear 18. Side gear 20 may thus have a second tooth profile. The second tooth profile may comprise a second segment comprising a plurality of sections. The second segment of the second tooth profile may correspond to the flank G of the tooth 21 on a side gear 20. Although three sections for the first and second segments are described in detail, the first and second segments of the modified first tooth profile and modified second tooth profile may each have greater or fewer sections in accordance with other embodiments of the invention.

In accordance with an embodiment of the invention, the modified first tooth profile for tooth flank P for pinion gear 18 and/or modified second tooth profile for tooth flank G for side gear 20 may have one or more sections in the first or second segments in which the tooth profile angle φₙ^{dm}, φₙ^{am} is increased as compared to a nominal tooth profile angle φₙ for a conventional tooth flank with a nominal tooth profile. The maximal allowed angle of tooth modification (i.e., increase in tooth profile angle as compared to a nominal tooth profile angle) may be limited by the shortest allowed width of a top land of the pinion gear 18 and the side gear 20. The modification of the tooth profile angle that may result in any tooth pointing must be eliminated.

The nominal tooth profile does not exist in accordance with the present invention, but is used as the reference profile for the modified portions of the actual tooth profile in accordance with an embodiment of the invention (e.g., modified first tooth profile for tooth flank P and modified second tooth profile for tooth flank G). In other words, the modified first tooth profile for tooth flank P for pinion gear 18 and/or the modified second tooth profile for tooth flank G for side gear 20 is specified in terms that relate to the nominal tooth profile. For example, the modified tooth profile angle may be about 0° to about 5° greater than the nominal profile angle φₙ for a conventional tooth flank (i.e., about +0°-5°). The nominal profile angle φₙ may be about 20° in accordance with some embodiments. Gears with a nominal tooth profile (e.g., a non-modified tooth profile) have the nominal profile. In contrast, modified gears in accordance with an embodiment of the present invention have a phantom (e.g., imaginary) nominal profile. The actual tooth profile of the modified gears in accordance with an embodiment of the invention differs partially or in whole from the phantom (e.g., imaginary) nominal profile.

In accordance with an embodiment of the invention, the modified first tooth profile for tooth flank P for pinion gear 18 and/or modified second tooth profile for tooth flank G for side gear 20 may have one or more sections in the first or second segments in which the tooth profile angle φₙ is decreased as compared to a nominal tooth profile angle for a conventional tooth flank. For example, the modified tooth profile angle may be about 0° to about 5° less than the nominal profile angle for a conventional tooth flank (i.e., about −0°-5°). Decreases in the tooth profile angle φₙ as compared to the nominal tooth profile angle of a conventional tooth flank for a conventional pinion gear and/or side gear at one or more particular locations along the tooth flank of the gear teeth on the pinion gear and/or side gear may increase the amount of contact stress on the gear tooth at those particular locations.

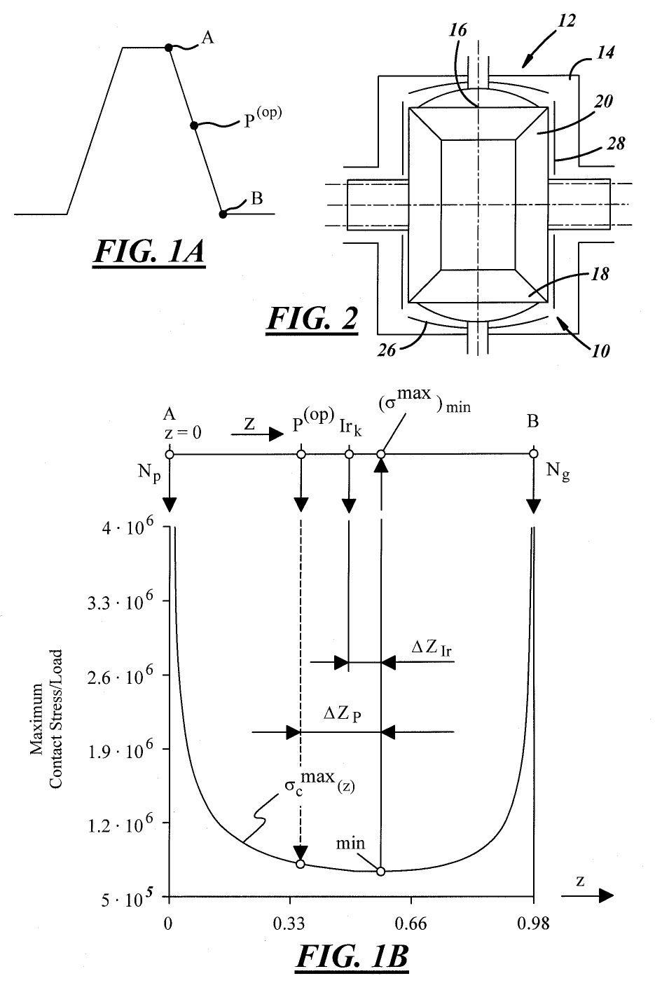

The modified auxiliary rack R* may be used to generate a modified tooth profile with a segment comprised of three sections. The modified tooth profile for a tooth 19, 21 including tooth flank P, G on pinion gear 18 and/or side gear 20, respectively, may comprise a segment comprising three sections corresponding to sections C, D, E illustrated in FIG. 9. Section C may correspond to a first (e.g., upper) portion of the segment of the tooth profile and may extend from where the first end (e.g., top) of the tooth profile meets the segment of the tooth profile (i.e., corresponding to location A in FIGS. 1A and 9) to a point between location A and pitch point P^{(op)} (i.e., corresponding to location F in FIGS. 1A and 9). Section C (i.e., the first section) may have an increased pressure angle φₙ^{dm}>φₙ. Increasing the pressure angle along section C may decrease the stress on the gear tooth along the first section C.

Section D may correspond to a second (e.g., middle) portion of the tooth profile and may extend from the point between location A and pitch point P^{(op)} (i.e., corresponding to location F in FIG. 9) through the pitch point P^{(op)} to a point (e.g., corresponding to location G in FIG. 9) between the pitch point P^{(op)} and location B where the segment of the tooth profile meets the bottom portion of the tooth profile. Section D (i.e., the second and/or middle section) may have a pressure angle that is smaller compared to the original value it may have had with a conventional gear tooth profile (i.e., φₙ^{m}<φₙ). Decreasing the pressure angle along section D may be allowable since the conventional pressure angle of a conventional tooth profile at section D (i.e., at the pitch point P^{(op)}) is generally strong enough to sustain the contact stress (as depicted in FIG. 1B), and may sustain even additional contact stress along second section D.

Section E may correspond to a third (e.g., lower) portion of the tooth profile and may extend from the point between the pitch point P^{(op)} and location B (i.e., corresponding to location G in FIG. 9) to where the segment of the tooth profile meets the second end (e.g., bottom) of the tooth profile (i.e., corresponding to location B in FIGS. 1A and 9). Section E (i.e., the bottom section) may also have an increased pressure angle φₙ^{am}>φₙ. Increasing the pressure angle along section E may decrease the stress on the gear tooth along third section E.

Modification to the profile angle at both sections C and E (i.e., φₙ^{dm}, φₙ^{am}) may be configured to help ensure meshing between gear teeth 19, 21 having a tooth flank P, G in accordance with a tooth profile generated by the modified auxiliary rack R*. The increased pressure angles φₙ^{dm}, φₙ^{am} at sections C, E may allow larger contact load in the pinion gear 18 to side gear 20 mesh, and the decreased pressure angle φₙ^{m} at section D may help to substantially reduce and/or eliminate tooth profile pointing.

The modifications to profile angle along the first, second, and third sections C, D, E may result in a modified tooth profile for a tooth 19, 21 on a pinion gear 18 and/or side gear 20 having tooth flanks P, G, respectively, in which the modified tooth profile comprises a segment comprising three sections C, D, E, each with straight surfaces and/or edges where each section C, D, E meets an adjacent section. Accordingly, tooth flanks P, G may comprise one or more flat surfaces meeting at different angles. While the three flat surfaces meeting at different angles may be particularly useful for engineering and/or manufacturing of teeth incorporating the modified tooth profile, the sharp corners between the transitioning flat surfaces of each of the three portions may be smoothed over time as the pinion gear 18 and side gear 20 are used. Alternatively, the three flat surfaces of sections C, D, E may be approximated into a smooth curve prior to engineering and/or manufacturing of gear teeth incorporating the modified tooth profile. Accordingly, tooth flanks P, G may comprise a curved surface. The modification to the profile angles φₙ^{dm}, φₙ^{m}, φₙ^{am} along the first, second, and third sections C, D, E, respectively, may function to substantially equalize the contact stresses at each of the three sections of the gear tooth profile.

The modified geometry of the tooth flanks P, G of the pinion gear 18 and side gear 20 that are generated using the modified auxiliary rack R* may cause movement of the plane of action (represented by corresponding line of action 30, 30₁, 30₂ in FIG. 6) when the tooth flanks P, G are in meshed engagement. The plane of action may define contact points between a first tooth flank P of pinion gear 18 and a second tooth flank G of side gear 20 of gear set 10. The line of action 30 may rotate around the pitch point P^{(op)} in accordance with an embodiment of the invention. FIG. 6 illustrates the rotation of the line of action 30, 30₁, 30₂. The rotation of the line of action 30, 30₁, 30₂ may take place at the transition between each of the portions C, D, E of the modified tooth profile generated by the modified auxiliary rack R*. For example, rotation of the line of action 30, 30₁, 30₂ may take place at points F, G as generally illustrated in FIG. 9. The modified tooth profile for pinion gear 18 and side gear 20 in accordance with an embodiment of the invention may be described analytically in connection with the rotation and/or oscillation of the line of action 30, 30₁, 30₂ generally illustrated in FIG. 6. An equation to represent modification of the tooth flanks P, G for the teeth 19 of pinion gear 18 and the teeth 21 of side gear 20 in connection with rotation and/or oscillation of the line of action 30, 30₁, 30₂ can be derived as set forth below.

For bevel gears, the following equation is valid:

sin θₚ=sin θ_{w.p}·sin φₙ(t) (Equation 11)

In Equation 11, θ_{w.p} denotes pitch cone angle and is a constant value and t denotes time. The following equation follows from Equation 11 for the angle θₚ(t) in terms of time t.

θₚ(t)=sin ⁻¹[ sin θ_{w.p}·sin φₙ(t)] (Equation 12)

When the gear is rotating, then an angle φₚ through the pinion 18 turns about its axis in time t is equal to φₚ=ωₚ·t, where ωₚ denotes rotation of the pinion gear 18. Accordingly, time t may be replaced with the following expression:

$$t = \frac{{ϕ}_{p}}{{ω}_{p}} .$$

Ultimately, this expression for t allows for an expression θₚ(φₚ), which is equivalent to the expression θₚ(t) set forth above in Equation 12. The equation for the position vector of a point rₚ^{mod if} of the tooth flank P of the modified pinion gear 18 may be derived by substituting Equation 12 into Equation 8 described herein.

$${r}_{p}^{mod if} ( {ϕ}_{p} , {U}_{p} ) = \\ [ \begin{matrix}{U}_{p} tan {θ}_{p} ( {ϕ}_{p} ) sin {ϕ}_{p} - {ϕ}_{p} \cdot {U}_{p} \cdot tan {θ}_{p} ( {ϕ}_{p} ) cos {ϕ}_{p} \\ {U}_{p} tan {θ}_{p} ( {ϕ}_{p} ) cos {ϕ}_{p} + {ϕ}_{p} \cdot {U}_{p} \cdot tan {θ}_{p} ( {ϕ}_{p} ) sin {ϕ}_{p} \\ - {U}_{p} \\ 1\end{matrix} ] \qquad ( Equation 13 )$$

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed is:

1. A gear set comprising:
a first gear having at least one tooth with a first tooth profile,
wherein the first tooth profile comprises a first segment comprising a first plurality of sections,
wherein at least one of the first plurality of sections has a first profile angle,
wherein at least one of the first plurality of sections has a second profile angle, and
wherein the first profile angle is different than the second profile angle.

2. The gear set of claim 1, further comprising a second gear having at least one tooth with a second tooth profile, wherein the second tooth profile comprises a second segment with a second plurality of sections, wherein at least one of the second plurality of sections has a first profile angle, wherein at least one of the second plurality of sections has a second profile angle, wherein the first profile angle for at least one of the second plurality of sections is different than the second profile angle for at least one of the second plurality of sections.

3. The gear set of claim 2, wherein the at least one tooth of the first gear and the at least one tooth of the second gear are configured to be in meshed engagement.

4. The gear set of claim 1, wherein the first profile angle is about 0° to about 5° greater than a nominal profile angle for the at least one tooth of the first gear.

5. The gear set of claim 2, wherein the second profile angle is about 0° to about 5° less than a nominal profile angle for the at least one tooth of the second gear.

6. The gear set of claim 1, wherein the first profile angle is configured to decrease the amount of contact stress on the at least one tooth of the first gear along at least a portion of the first tooth profile.

7. The gear set of claim 2, wherein the second profile angle is configured to decrease the amount of contact stress on the at least one tooth of the second gear along at least a portion of the second tooth profile.

8. The gear set of claim 1, wherein the first profile angle is greater than the second profile angle.

9. The gear set of claim 8, wherein the first profile angle is about 0° to about 10° greater than the second profile angle.

10. The gear set of claim 1, wherein the first plurality of sections comprises a first section, a second section, and a third section.

11. The gear set of claim 10, wherein the first section has the first profile angle.

12. The gear set of claim 11, wherein the second section has the second profile angle.

13. The gear set of claim 12, wherein the third section has the first profile angle.

14. The gear set of claim 13, wherein the second section is located between the first section and the third section.

15. The gear set of claim 14, wherein the first tooth profile has a first pitch point, and wherein the first section extends from a first end of the first tooth profile to a first location disposed between the first end and the pitch point.

16. The gear set of claim 15, wherein the second section extends from the first location, through the pitch point, to a second location disposed between the pitch point and a second end of the first tooth profile.

17. The gear set of claim 16, wherein the third section extends from the second location to the second end of the first tooth profile.

18. The gear set of claim 14, wherein the first section, second section, and third section comprise a curve.

19. A differential comprising:
a differential case;
a pinion shaft disposed inside the differential case;
a pinion gear having at least one tooth with a first tooth profile,
wherein the first tooth profile comprises a first segment comprising a first plurality of sections;
wherein at least one of the first plurality of sections has a first profile angle,
wherein at least one of the first plurality of sections has a second profile angle, and
wherein the first profile angle is different than the second profile angle.

20. The differential of claim 19, further comprising a side gear having at least one tooth with a second tooth profile, wherein the second tooth profile comprises a second segment with a second plurality of sections, wherein at least one of the second plurality of sections has a first profile angle, wherein at least one of the second plurality of sections has a second profile angle, wherein the first profile angle for at least one of the second plurality of sections is different than the second profile angle for at least one of the second plurality of sections.
